(19) United States
(12) Patent Application Publication
(10) Pub. No.: US 2008/0086867 A1
(43) Pub. Date: Apr. 17, 2008

(54) Circuit component locating apparatus

(76) Inventor: Geoffrey H. Kerr, Ormskirk (NU)

Correspondence Address: DELPHI TECHNOLOGIES, INC., M/C 480-410-202, PO BOX 5052, TROY, MI, 48007, US

(21) Appl. No.: 11/906,919

(22) Filed: Oct. 4, 2007

(30) Foreign Application Priority Data
Oct. 17, 2006 (EP) 06122447.3

(51) Int. Cl. B23P 19/00

(52) U.S. Cl. 29/592.1; 29/739; 361/679

(57) ABSTRACT

A circuit component locating apparatus is used to locate a circuit component, such as a resistor, capacitor etc. on a circuit board. The apparatus has an attachment member that projects from a fastening frame. The attachment member extends around the circuit component to provide a gap which can receive adhesive in order to secure the circuit component to the attachment member. The apparatus is particularly useful for minimizing the effect of vibrations on circuit boards of an automobile's Engine Control Unit (ECU).

### TECHNICAL FIELD OF INVENTION

The invention relates to a circuit component locating apparatus used to locate a component on a circuit board in an improved manner.

### BACKGROUND OF INVENTION

Circuit boards are widely used in many industries. For example, they are used in Engine Control Unit (ECUs) or Engine Control Modules (ECMs) in automobiles etc. The boards typically have a solid support board on which a number of electrical components are mounted. The dimensions (length, width diameter etc.) of the components varies widely depending upon the purpose of the overall circuit. A problem with relatively large components is that they can be vulnerable to forces from vibration/impact from the surrounding environment (this is particularly true in circuits boards used in ECUs and ECMs of automobiles where vibrations are produced by the engine/chassis).

Circuit boards are often surrounded by a case which protects the components from contaminants. With reference to FIG. 1, the protective case also ensures that the components are not displaced due to vibrational forces. This is achieved by dispensing an adhesive 2 into the bottom of the case 1. The component 3, which is attached to a circuit board 4 by soldered joints 5, is then pressed into the adhesive 2 in order to provide an adhesive connection between the top of the component 3 and the bottom of the case 1. The adhesive is then typically cured by heating and subsequent cooling of the entire arrangement.

A problem with this method of securing the component is that both the case 1 and adhesive 2 have a tendency to expand, during the curing operation, and contract when they cool (or when the vehicle is used in a cold climate). Since the adhesive 2 is positioned on top of the component 3, any expansion and contraction of the adhesive 2 exerts forces on the component and thus the soldered joints 5 between the component 3 and the circuit board 4. This can eventually lead to failure of the soldered joint and hence failure of the entire circuit board.

### SUMMARY OF THE INVENTION

This invention relates to a circuit component locating apparatus for locating a circuit component on a circuit board. More particularly, the circuit component locating apparatus comprises a fastening frame and an attachment member projecting from the fastening frame and extending at least partially around the located circuit component.

### BRIEF DESCRIPTION OF THE DRAWINGS

Embodiments of the invention will now be described, by way of example only, with reference to the drawings, in which:

FIG. 1 is a partial cross sectional view of a prior art arrangement which is not in accordance with the invention. In this arrangement an outer case surrounds the component. Adhesive is provided between the top of the component and the bottom of the case;

FIG. 2 is a perspective view of an embodiment of the apparatus in accordance with the present invention viewed from above, where the apparatus locates a cylindrical circuit component;

FIG. 3 is a perspective view of the apparatus of FIG. 1 from one side, where a cover plate is positioned around the cylindrical circuit component;

FIG. 4A is a transverse cross sectional view of the apparatus of FIG. 2; and

FIG. 4B is a transverse cross sectional view of the apparatus of FIG. 2 with the cover plate positioned around the cylindrical circuit component.

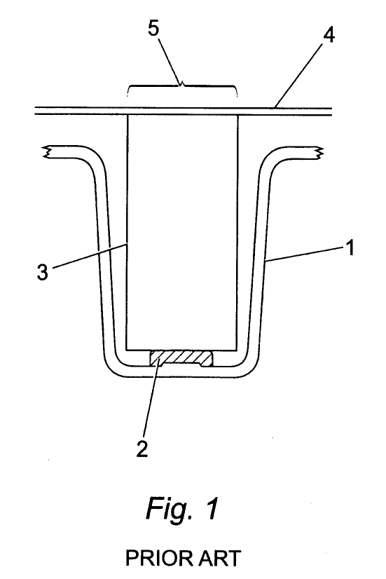

### DETAILED DESCRIPTION OF INVENTION

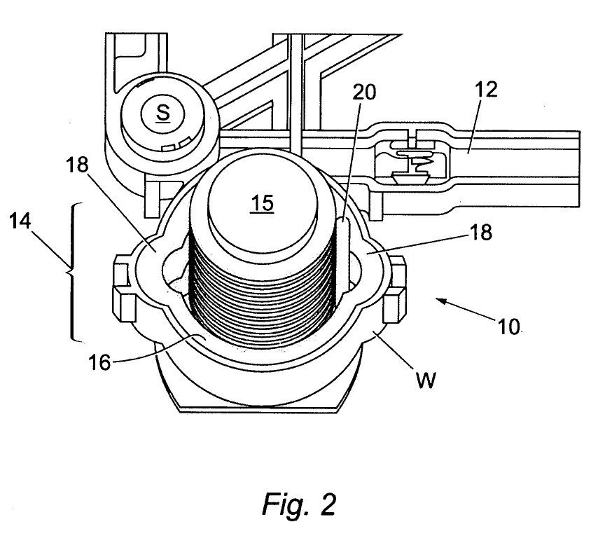

With reference to FIG. 2 circuit component locating apparatus 10 includes a fastening frame 12 having an extension 14 projecting therefrom. The fastening frame 12 is in the form of a discrete frame member which can be attached to a circuit board with a number of locating rivets or screws S. The extension 14 has an aperture therethrough which is shaped to accept a correspondingly shaped circuit component 15. In the embodiment shown the aperture is circular in order to accept a cylindrical circuit component 15, although it will be appreciated that the aperture could be any shape corresponding to a cross sectional shape of the circuit component 15, for example, rectangular, square, triangular etc. The aperture is slightly larger than the circuit component around which it is to be placed in order to provide a space in which adhesive means, such as glue, may be provided. The size of the aperture can also be increased to aid positioning of the frame over the circuit component 15 by accepting manufacturing tolerances in the dimensions of the circuit component 15.

An attachment member, or wall W, is provided around the aperture and has a lip at the opening of the aperture. The lip is angled relative to the central axis of the aperture in order to form a ledge 16. The ledge 16 is also contoured at locations 18 in order to maintain a substantially constant space between the wall W and the circuit component 15 taking account of any projecting connections 20 on the circuit component 15. As shown in FIG. 2, a redundancy may be incorporated into the apparatus by providing the contoured sections 18 at either side of the component 15. This also allows the apparatus to fit properly over a component which is attached to the circuit board in the opposite direction (rotated through an angle of 180 degrees).

In use, the apparatus 10 is placed over the various components of the circuit board, ensuring that each aperture of each extension 14 is placed around each circuit component. Once in position over the circuit components, the fastening frame 12 is then secured to the circuit board by locating screws S. In order to secure, the circuit components 15 to the fastening frame 12 (and hence relative to the circuit board) an adhesive is applied around the ledge 16. The angle of the ledge 16 is oriented such that the adhesive begins to flow toward the component 15 and into engagement with both the inner side surface of the wall W and the outer side surface of the circuit component 15 adjacent the wall W. In the present embodiment the ledge is angled at 45 degrees; however, any angle capable of providing the desired function may be used.

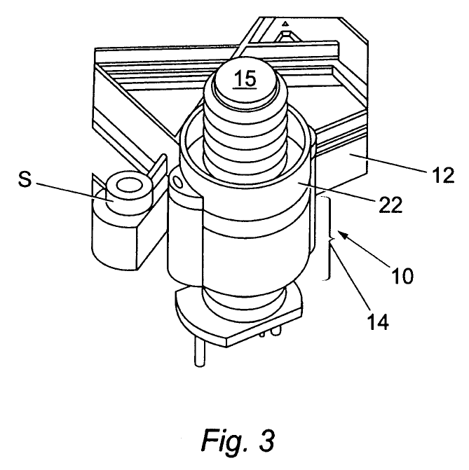

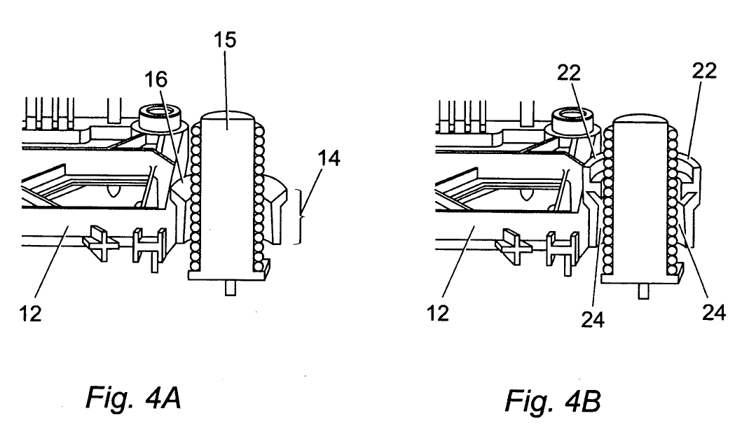

With reference to FIG. 3, some adhesives do not flow easily and may not flow into engagement with the circuit component. To overcome this, a cover plate 22 is placed around the circuit component 15. The cover plate may be a separate member or may be integrated into the apparatus by way of a hinge (not shown) which allows it to simply flip over the circuit component from a storage position to an active position. The cover plate 22 is then progressed down the circuit component until a snap fit connection is formed between the cover plate 22 and the wall ledge 16. This causes any adhesive residing on the ledge 16 to be pushed down into the space between the wall W and circuit component 15. In this regard, the lower face of the cover plate 22 is shaped to correspond with the ledge of the wall W. The final position of the adhesive is referenced 24 in FIG. 4B. When in position, the cover plate also has the additional effect of sealing the top of the space between the wall and circuit component. Furthermore, the inner shape of the cover plate may be such that it fits closely around the circuit component 15 and provides some additional lateral support to the circuit component 15.

The apparatus described allows an adhesive connection to be provided between the side of the circuit component and the wall. With such an arrangement, the effect of any expansion and contraction of the adhesive on the soldered joints of the circuit component is minimised.

The arrangement securely attaches the circuit components to the circuit board and therefore eliminates the need for securing the components using the casing. This further eliminates any stress on the circuit component soldered joints which would otherwise be caused by the interaction between the casing and the components during expansion and contraction.

Modifications, and improvements may be made to the foregoing without departing from the scope of the invention, for example:

Although the apparatus in the embodiment shown in FIGS. 2 to 4 is incorporated into a discrete frame member 12, alternatively, the apparatus may be provided directly onto a circuit board.

While this invention has been described in terms of the preferred embodiments thereof, it is not intended to be so limited, but rather only to the extent set forth in the claims that follow.

We claim:

1. A circuit component locating apparatus for locating a circuit component on a circuit board, the circuit component locating apparatus comprising:
a fastening frame; and
an attachment member projecting from the fastening frame and extending at least partially around the located circuit component.

2. A circuit component locating apparatus according to claim 1, wherein the attachment member is spaced apart from the located circuit component and defines a space between the attachment member and said circuit component, said space being capable of receiving adhesive means for securing the circuit component to the attachment member.

3. A circuit component locating apparatus according to claim 1, wherein the attachment member is adapted to allow connection of a side face of the attachment member of said circuit component.

4. A circuit component locating apparatus according to claim 1, wherein the fastening frame comprises a portion of a circuit board.

5. A circuit component locating apparatus according to claim 1, wherein the fastening frame comprises a plurality of members connected to form a framework capable of being fastened to a circuit board.

6. A circuit component locating apparatus according to claim 5, wherein the framework is provided with at least an aperture capable of receiving the circuit component.

7. A circuit component locating apparatus according to claim 6, wherein the attachment member is spaced apart from the aperture by a distance suitable to provide a space for allowing the adhesive means to be dispensed into the space between the attachment member and the circuit component.

8. A circuit component locating apparatus according to claim 1, wherein the attachment member extends all of the way around the component.

9. A circuit component locating apparatus according to claim 2, further comprising a cover plate corresponding to the space between the attachment member and the component, wherein when the cover plate is placed into engagement with a lip of the attachment member; and where adhesive present on the lip of the attachment member is urged into the space and into communication with the attachment member and the circuit component, providing an adhesive connection there between.

10. A circuit component locating apparatus according to claim 9, wherein the cover plate is adapted to snap fit into securing engagement with the attachment member and circuit component.

11. A circuit component locating apparatus according to claim 9, wherein the cover plate is integrated into the apparatus by way of a hinge member which allows the cover plate to hinge from a first storage position to a second active position.

12. A circuit component locating apparatus according to claim 6, wherein the attachment member and aperture are shaped to correspond with the shape of the circuit component.

13. A circuit component locating apparatus according to claim 2, wherein the attachment member is angled relative to a longitudinal axis of the circuit component in order to provide a ledge for urging the adhesive means into contact with the circuit component.
